(19) United States
(12) Patent Application Publication
(10) Pub. No.: US 2021/0158723 A1
(43) Pub. Date: May 27, 2021

(54) Method and System for Teaching Language via Multimedia Content

(71) Applicant: LANGA LTD., Mishmar David (IL)

(72) Inventor: Omri YALOVSKI, Mishmar David (IL)

(21) Appl. No.: 15/734,610

(22) PCT Filed: Jun. 17, 2019
(86) PCT No.: PCT/IB2019/055053

§ 371 Date: Dec. 3, 2020

Related U.S. Application Data
(60) Provisional application No. 62/686,038, filed on Jun. 17, 2018.

(51) Int. Cl. G09B 19/06; G09B 5/06

(52) U.S. Cl. CPC G09B 19/06; G09B 5/06

(57) ABSTRACT

The subject matter discloses is a language teaching system that adapts the multimedia content to the viewer's knowledge level. According to some embodiments, the system automatically adapts the subtitle of the particular multimedia content to fit the knowledge of the viewer while translating the words being taught. The method comprises receiving a request for learning a foreign language from a subtitle of a multimedia content.

### CROSS-REFERENCE TO RELATED APPLICATION

This application claims priority to U.S. Provisional Patent Application No. 62/686,038, filed Jun. 17, 2018, and entitled “Method and System for Teaching Language Via Multimedia Content”, the disclosure of which is hereby expressly incorporated by reference in its entirety.

### FIELD OF THE INVENTION

The present disclosure relates to multimedia content in general, and to subtitles for translating the audio of the multimedia content, in particular.

### BACKGROUND OF THE INVENTION

Many people are interested in learning a new language, practice a language in a way that does not demand effort or much money. Yet, they struggle to enter an affective and enjoyable program. However, the market offers variety of apps, and different schools for learning language.

### SUMMARY OF THE INVENTION

The term multimedia refers herein to text, icons video and audio. The multimedia may be played over the web (internet) on demand or by steaming.

The term native language refers herein to the language in which the subtitles are presented to the user. The native language is typically the native language of the user.

The term foreign language refers herein to the language to which the word is translated to. The foreign language is typically the language that the user wishes to learn.

One exemplary embodiment of the disclosed subject matter is a language teaching system, using the multimedia content such as T.V program and automatically adapts the multimedia content to the viewer's knowledge level.

According to some embodiments, the system automatically adapts the subtitle of the particular multimedia content to fit the knowledge of the viewer while translating the words being taught. The words that are not taught are not changed in the subtitle.

Initially, the system may test the level of knowledge of the viewers in the selected language by assigning tests. Then the system detects the level of subtitle and script needed to be played to the viewer. A personal program structured and fitted to the viewer's level and viewing preferences.

According to some embodiments, the system improves reading and listening comprehension. Typically, the user of system turns instinctively first to the text in one's native language, as it is easier for one to read. Then the user typically compares to what been said in the multimedia content. Slowly the viewer starts reading the learned language and thus, strengthening his reading comprehension. Thus, the text support brings more of a listening comprehension much easily. People tend to activities that demand less effort, so listening is easier than reading, hence they prefer listening, which is what embodiments of the invention aim for. According to some embodiments the system utilizes the time that the user spends on watching multimedia content as a platform for learning a language.

One exemplary embodiment of the disclosed subject matter is A method, the method comprises: receiving a request for learning a foreign language from a subtitle of a multimedia content; the request comprising a level or a category of the learning; selecting from the subtitle a word or an idiom associated with the level or category; associating the word or the idioms with a corresponding entry in a dictionary file; wherein the corresponding entry comprising a translation of the word or the idiom into the foreign language; copying a first portion of the subtitle into an array; the first portion preceding the word or idiom in the subtitle; copying the word or idiom into the array successive to the first portion; copying the translation into the array successive to the word or idiom; copying a second portion of the subtitle into the array successive to the word or idiom in the subtitle; associating timing with the array; the timing is for playing the array as a subtitle in the timing while playing said multimedia content. According to some embodiments the method further comprising providing the array as a playable file for playing the subtitle while playing the multimedia content. According to some embodiments a direction of a language of the subtitle is opposite to a direction of the foreign language and further comprising reversing letters of the subtitle, moving the letters from the last index to the index that represents the location into which the word or idiom has to be inserted in the sentence such that each letter is inserted to a consecutive index, inserting the word or idiom; inserting the letters that are consecutive to the word or idiom into the array and reversing letters of the array; wherein the reversing is in accordance with standard word processing reversing procedure.

According to some embodiments the method further comprises associating a color to the word or the idiom for presenting the word or the idiom in the color. According to some embodiments the translation of the word or idiom comprising a plurality of meanings and wherein the method further comprising receiving a foreign subtitle, wherein the foreign subtitle corresponding to the subtitle, wherein the foreign subtitle being in the foreign language, identifying from the foreign subtitle a foreign word or a foreign idiom, the foreign word or foreign idiom corresponding to the word or the idiom and selecting from the plurality of meanings a the foreign idiom or foreign word.

One other exemplary embodiment of the disclosed subject matter is at least one non-transitory computer-readable storage medium having stored thereon instructions that, when executed by one or more processors, cause the one or more processors to perform operations comprising: receiving a request for learning a foreign language from a subtitle of a multimedia content; the request comprising a level or a category of the learning; selecting from the subtitle a word or an idiom associated with the level or category; associating the word or the idioms with a corresponding entry in a dictionary file; wherein the corresponding entry comprising a translation of the word or the idiom into the foreign language; copying a first portion of the subtitle into an array; the first portion preceding the word or idiom in the subtitle; copying the word or idiom into the array successive to the first portion; copying the translation into the array successive to the word or idiom; copying a second portion of the subtitle into the array successive to the word or idiom in the subtitle and associating timing with the array; the timing is for playing the array as a subtitle in the timing while playing the multimedia content.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method for teaching language via multimedia content, in accordance with some embodiments of the disclosed subject matter;

FIG. 2 shows an exemplary screen shot of TV show adapted to the user by the system for teaching language via multimedia content; in accordance with some embodiments of the disclosed subject matter;

FIG. 3 shows an exemplary second screen shot of TV show adapted to the user by the system for teaching language via multimedia content; in accordance with some embodiments of the disclosed subject matter;

FIG. 4 shows a scenario of using the system for teaching language via multimedia content, in accordance with some embodiments of the disclosed subject matter;

FIG. 5 shows a schematic block diagram of an exemplary dictionary file, in accordance with some embodiments of the disclosed subject matter;

FIG. 6 shows a schematic block diagram of a translated file, in accordance with some embodiments of the disclosed subject matter;

FIG. 7 shows a flowchart diagram of a method for building a dual language file, in accordance with some embodiments of the disclosed subject matter;

FIG. 8 shows a flowchart diagram of a method for building a playable file, in accordance with some embodiments of the disclosed subject matter; and

FIG. 9 shows a flowchart diagram of method of generating a playable file and of arranging the position of the letters in a sentence that includes words of languages with different directions.

### DETAILED DESCRIPTION

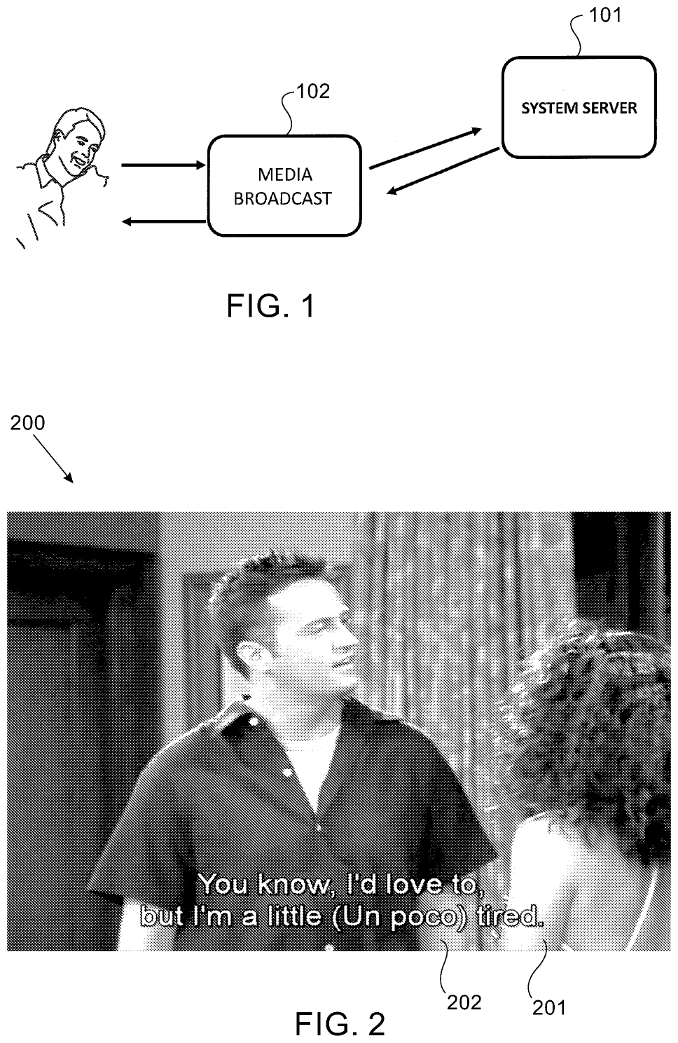

FIG. 1 shows a block diagram of a system for teaching language via multimedia content, in accordance with some embodiments of the disclosed subject matter. The system includes a server 101, media broadcast device 102. The sever 101 includes an algorithm for generating the multimedia content's subtitles. The algorithm generates unique subtitles to each viewer according to the viewer's knowledge. The server 101 contains a didactic data base of tests in accordance with vocabulary division to levels of knowledge of a specific language.

The media broadcast device 102 includes the multimedia content, and a regular script translation. The media broadcast device 102 can be a cable T.V, satellite T.V, computer, tablet etc. The media broadcast device 102 facilitates as the connecting method, between the viewer and the system server, which enables the viewer to excess the tests and unique subtitle. The server 101 feeds back through the media broadcast device 102 the unique subtitle fitting to the viewer, in accordance to the results of tests that the user has performed. The media broadcast device 102 synchronizes the media content and the unique subtitle back to the viewer for viewing and learning. The viewer communicates with the server 101 via the media broadcast device 102 to part take the tests and learn a chosen language by receiving a unique manipulated subtitle onto the desired multimedia content.

FIG. 2 shows an exemplary screen shot of TV show adapted to the user by the system for teaching language via multimedia content; in accordance with some embodiments of the disclosed subject matter.

The screen shot displays a scene 200. The screen shot includes the subtitle 201 and a translated word 202. The subtitle 201 includes words that are displayed in one color and words that are displayed in a second color (not shown in the figure). The words that are displayed in a second color are words that are selected by the system as words that require translation. In the exemplary screen shot 200, the translated word 202 is a Spanish word for enabling an English speaker to improve his Spanish.

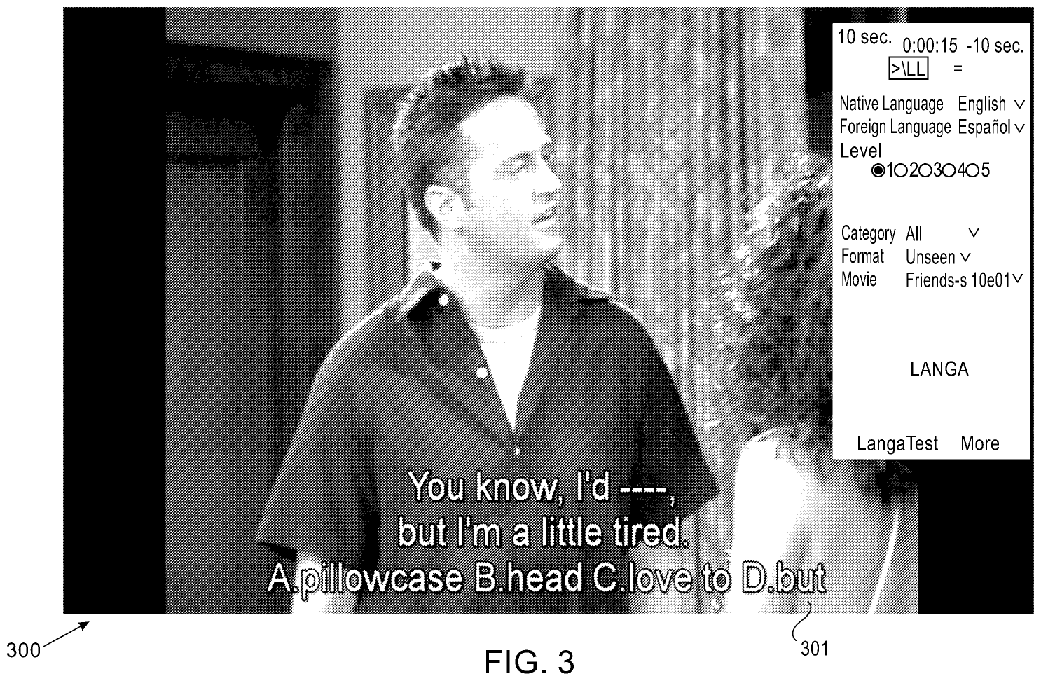

FIG. 3 shows an exemplary second screen shot of TV show adapted to the user by the system for teaching language as a test via multimedia content; in accordance with some embodiments of the disclosed subject matter. Screenshot 300 includes a test 301 that is provided to the user for adapting the titles to the level of the user.

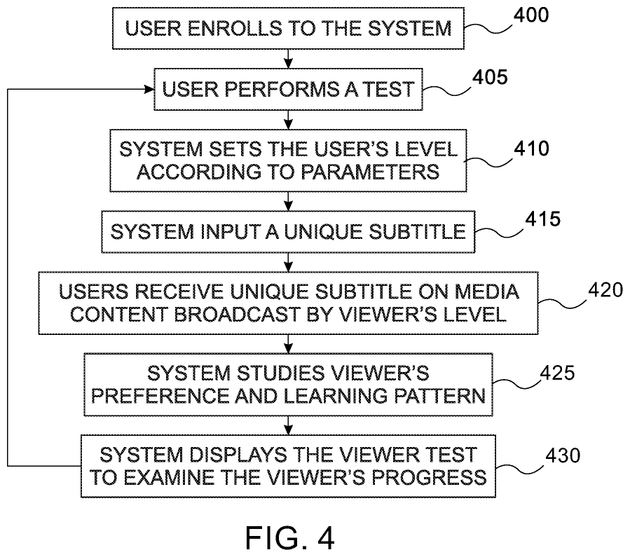

FIG. 4 shows a scenario of using the system for teaching language via multimedia content, in accordance with some embodiments of the disclosed subject matter.

At block 400, the user enrolls to the system for teaching language via multimedia content. Enrolling is performed via the use of the media broadcast. The user uses the controls the media broadcast to enter the system, chooses a desired language he wants to learn and desired media content.

At block 405, the user performs a test.

At block 410, the system sets the user's didactic level in the targeted language according to the results of the test.

At block 415, the system inputs unique subtitle back to the media broadcast, the media broadcast synchronizes the media content with the unique subtitle and displays the synchronized content to the viewer.

At block 420, the viewer watches the chosen media content with unique subtitles, suited to the viewer personally.

At block 425 the system study the viewer's preferences as to one's preferred media programs, as well the viewer's learning pattern. The system saves and examines the viewer's chosen media content, and results of tests, to be able to predict which media content the viewer will prefer next, so the system will know to suggests similar media content to the viewer, and prepare a unique subtitles for the suggested media content as well.

At block 430, the system displays to the viewer test to examine the viewer's progress in learning the chosen language. The process goes back to block 405 for readjusting the level of the user.

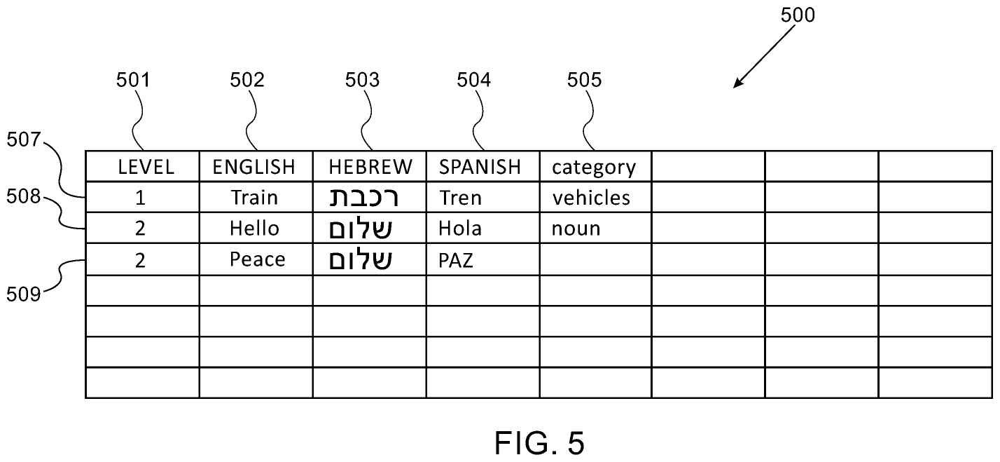

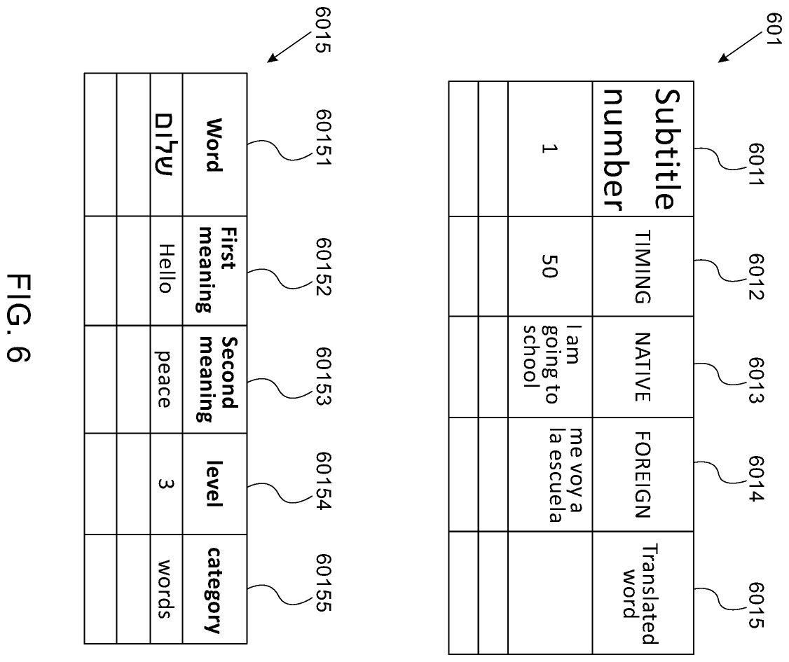

FIG. 5 shows a schematic block diagram of an exemplary dictionary file, in accordance with some embodiments of the disclosed subject matter.

Dictionary file 500 includes lines. Each line represents a word or an idiom. Line 507 represents the translation of the word train into a plurality of languages. Line 508 represents the translation of the word hello into a plurality of languages. Line 509 represents the translation of the word peace into a plurality of languages.

Column 501 represents the level of the word or idiom, column 502 represents the word in English, column 503 represents the word in Hebrew, column 504 represents the word in Spanish and column 505 represents the category of the word.

FIG. 6 shows a schematic block diagram of a translated file, in accordance with some embodiments of the disclosed subject matter.

According to some embodiments the translated file includes the following fields: subtitle number 6011, timing 6012, native 6013, foreign 6014 and translated table 6015.

The subtitle number 6011 includes the number of the subtitle.

The timing 6012 includes the timing (for example in seconds) in the multimedia that is associated with the subtitle.

The native 6013 includes the subtitle in the native language.

The foreign 6014 includes the subtitle in the foreign language.

The translated table 6015 includes a table with all the words or idioms in the subtitle and the translation of the words.

Translation table 6015 includes the fields: word 60151, first meaning 60152, second meaning 60153, level 60154 and category 60155.

Word 60151 includes a word from the subtitle.

First meaning 60152 includes a first meaning of the word.

Second meaning 60153 includes a second meaning of the word (if exists). It should be noted that a word may include one or more meanings.

Level 60154 includes the level of the word.

Category 60155 includes the category of the word.

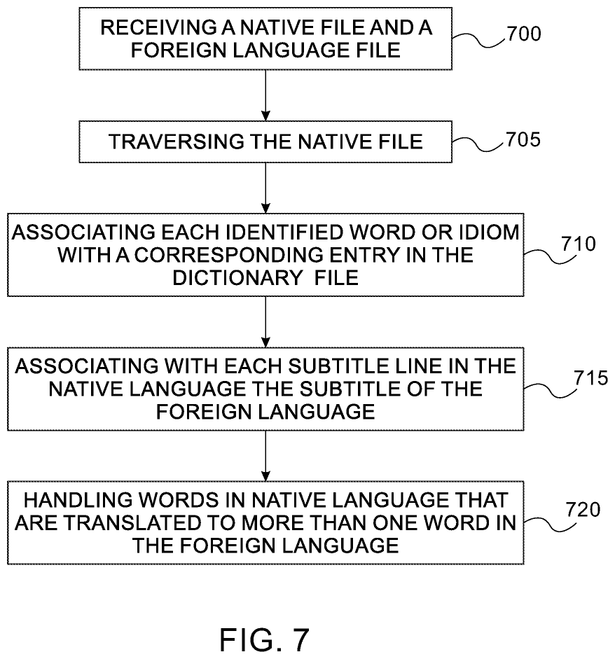

FIG. 7 shows a flowchart diagram of a method for building a dual language file, in accordance with some embodiments of the disclosed subject matter.

According to some embodiments the dual language file includes the translation of a subtitle of a certain native file into a foreign language. The language of the media content associated with the subtitle is typically the foreign language.

The dual language file is used as a basis for preparing the playing file. The playing file is a file that is played when playing the media content for presenting the translated words in the translation.

At block 700 the system receives a native file and a foreign language file. The foreign language file includes the subtitle of the media content in the foreign language (typically the language in which the media content is played). The native file includes the subtitle of the media content in the native language. In some embodiments if the format of the files is not SRT (Secure Reliable Transport) the system transform the files into SRT format.

At block 705 the system traverses the native file. The traversing is letter by letter for identifying all words and idioms in the subtitles. The traversing process matches sequences of letters to an idiom or a word in the dictionary file.

At block 710 the system associates each identified word or idiom with a corresponding entry in the dictionary file. The associating may be by copying the corresponding entry from the dictionary file or by pointing to the corresponding entry. If there is no such entry in the dictionary file the system marks the identified word or idiom as non-translated.

At block 715 the system associates with each subtitle line in the native language the subtitle line of the foreign language. The associating may be by copying the corresponding subtitle line from the foreign file or by pointing to the corresponding subtitle line in the foreign file. The corresponding subtitle is the subtitle of the same scene.

At block 720 the system handles words in native language that are translated to more than one word in the foreign language (ambiguous words. The system searches in the corresponding subtitle (subtitle of the same timing) for the appearance of one of the ambiguous words. If such a word appears in the subtitle the word is selected as the translated word. If there is no corresponding subtitle, the system may select arbitrary one of the ambiguous words as the translated word.

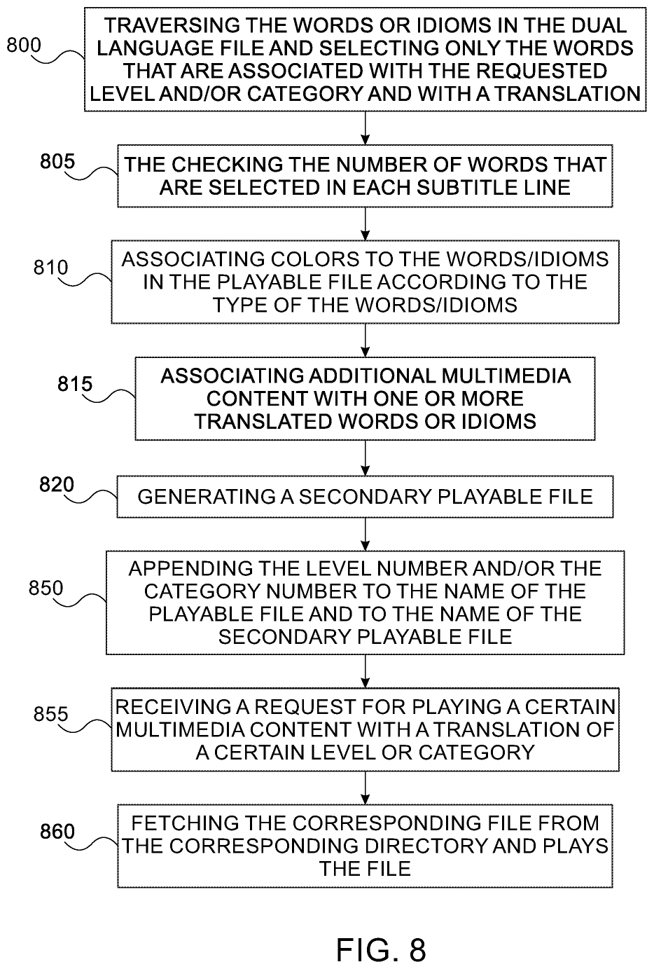

FIG. 8 shows a flowchart diagram of a method for building a playable file, in accordance with some embodiments of the disclosed subject matter. The playable file is a file that is used for playing the subtitles of the multimedia content such that the subtitles in the native language include a translation of selected words into the foreign language. The selected words are selected according to level of difficulty or according to category. In one embodiment the system builds playable files for all levels and for all categories of certain media content. In one other embodiment the system builds a playable file upon a request from a user; in such a case the user selects the level and/or category that he is interested in.

When playing the playable file the translated words (words in the selected level or category that are translated from the native language to the foreign language) are embedded in the native language subtitles.

At block 800 the system traverses the words or idioms in the dual language file and selects only the words that are associated with the requested level and/or category and with a translation. (Words or idioms without translation are not selected) The system also counts the number of occurrences of each word/idiom in the file.

At block 805 the system checks the number of words that are selected in each subtitle line. If there is more than one word the system may remove the words that appear more frequently in the text.

At block 810 the system associates colors to the words/idioms in the playable file according to the type of the words/idioms; for example, a non translated word or an idiom may associate with a first color (e.g. white); and a translated word or an idiom maybe associated with a second color (e.g. red). In some cases the directions of the sentence the native language and the translated language are not equal (e.g. the direction of English is left to right); in such a case the system arranges the positions of the letters (including the translated word) such that the translated word is displayed adjacent to the word in the native language while maintaining the order of the words in the sentence and the direction of the sentence.

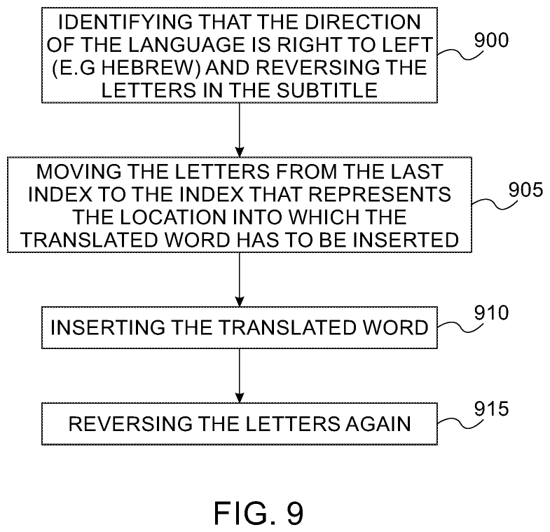

The method of arranging the position of the letters in a sentence that includes words of languages with different directions is explained in greater details in FIG. 9.

At block 815 the system associates additional multimedia content with one or more translated words or idioms. The additional multimedia content may include a meaning of the translated word or an advertisement associated with the additional word etc. The system sets the time duration and location on screen in which the additional multimedia content is played. In some embodiments the system adjusts the duration and the timing of playing the additional multimedia content with the frequency of the translated words; that is to say, if the duration between a translated word to another translated word is long (e.g. more than 10 milliseconds) the system defines a longer duration (e.g. 6 milliseconds) for playing the additional multimedia of the first word. Additionally or optionally the system may define the start time for playing the additional multimedia that is associated with the other word to be prior to the time of displaying the other word, such that the additional multimedia of the other word is played before the displaying of the other translated word for attracting the attention of the user.

In another embodiment if the duration between a translated word to another translated word is short (e.g. less than 10 milliseconds) the system may define a shorter duration (e.g. 2 milliseconds) for playing the additional multimedia.

At block 820 the system generates a secondary playable file. The secondary playable file may be used upon a request from the user to display only the translated words (without the subtitle). The secondary playable file includes the translated words only and the data that is associated with the translated words.

At block 850 the system appends the level number and/or the category number to the name of the playable file and to the name of the secondary playable file. The system stores the playable file and the secondary playable file in a dedicated directory. Such directory is configured for storing the playable file of the multimedia content in various levels and categories for a certain native language and for a certain learning language.

At block 855 a request is received for playing a certain multimedia content with a translation of a certain level or category.

At block 860 the system fetches the corresponding file from the corresponding directory generates a playable and plays the playable file. The method for generating the playable file is explained in greater details in FIG. 9.

FIG. 9 shows a flowchart diagram of method of generating a playable file and for arranging the position of the letters in a sentence that includes words of languages with different directions.

In some cases the translated word in a subtitle is of a language whose sentences are written from left to right (e.g. English) while the native language is of a language whose sentences are written from right to left (e.g. Hebrew) Referring now to the drawings:

At block 900 the system identifies that the direction of the language is right to left (e.g. Hebrew) and reverses the letters in the subtitle. The reversing may be performed by the word processor or by dedicated software. In one example each letter in the sentence of the subtitle is written in an entry of an array wherein each entry is associated with an index. In such an example before the reversing entry of index 1 includes the first letter of the sentence, entry of index 2 includes the second letter and so on. After the reversing entry of index 1 includes the last letter of the sentence, entry of index 2 includes the second last letter and so on.

At block 905 the system moves the letters from the last index to the index that represents the location into which the translated word has to be inserted in the sentence such that each letter is inserted to a consecutive index. The location of into which the translated word has to be inserted may be the index of the last letter of the word to be translated in the native language.

At block 910 the system inserts the translated word. In some embodiment the translated word includes also additional symbols such as parentheses and space. The system also inserts the letters that are consecutive to the word or idiom into the array.

At block 915 the system reverses the letters again by using standard word processor reversing procedure.

It should be noted that the same procedure may be used when the native language and the foreign language are in the same direction. In such a case the standard reversing procedure does not revere the letters. In other embodiments the system does not perform the reversing in such a case.

In some cases one or more words of the subtitle are assigned with a color in order to display the word in that color. In some embodiment the coloring is performed by inserting a coloring command start coloring before the word and another coloring command stop coloring after the end of the word. The coloring commands are typically written from left to right. One problem is how to handle the insertion of a word in a language with a different direction while maintaining the order of the coloring commands.

The solution is by coloring the word only after the reversing of block 915.

It should be noted that the method of arranging the position of the letters in a sentence that includes words of languages with different directions may also be used when working with the dual language file or with the dictionary file.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, and the like. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, the method comprises:
receiving a request for learning a foreign language from a subtitle of a multimedia content; said request comprising a level or a category of said learning;
selecting from said subtitle a word or an idiom associated with said level or category;
associating said word or said idioms with a corresponding entry in a dictionary file; wherein said corresponding entry comprising a translation of said word or said idiom into said foreign language;
copying a first portion of said subtitle into an array; said first portion preceding said word or idiom in said subtitle;
copying said word or idiom into said array successive to said first portion;
copying said translation into said array successive to said word or idiom;
copying a second portion of said subtitle into said array successive to said word or idiom in said subtitle;
associating timing with said array; said timing is for playing said array as a subtitle in said timing while playing said multimedia content.

2. The method of claim 1 further comprising providing said array as a playable file for playing said subtitle while playing said multimedia content.

3. The method of claim 1, wherein a direction of a language of said subtitle is opposite to a direction of said foreign language and further comprising reversing letters of said subtitle, moving said letters from said last index to the index that represents the location into which said word or idiom has to be inserted in the sentence such that each letter is inserted to a consecutive index, inserting said word or idiom; inserting the letters that are consecutive to said word or idiom into said array and reversing letters of said array; wherein said reversing is in accordance with standard word processing reversing procedure.

4. The method of claim 1, further comprising associating a color to said word or said idiom for presenting said word or said idiom in said color.

5. The method of claim 1, wherein said translation of said word or idiom comprising a plurality of meanings and wherein said method further comprising receiving a foreign subtitle, wherein said foreign subtitle corresponding to said subtitle, wherein said foreign subtitle being in said foreign language, identifying from said foreign subtitle a foreign word or a foreign idiom, said foreign word or foreign idiom corresponding to said word or said idiom and selecting from said plurality of meanings a said foreign idiom or foreign word.

6. At least one non-transitory computer-readable storage medium having stored thereon instructions that, when executed by one or more processors, cause the one or more processors to perform operations comprising:
receiving a request for learning a foreign language from a subtitle of a multimedia content; said request comprising a level or a category of said learning;
selecting from said subtitle a word or an idiom associated with said level or category;
associating said word or said idioms with a corresponding entry in a dictionary file; wherein said corresponding entry comprising a translation of said word or said idiom into said foreign language;
copying a first portion of said subtitle into an array; said first portion preceding said word or idiom in said subtitle;
copying said word or idiom into said array successive to said first portion;
copying said translation into said array successive to said word or idiom;
copying a second portion of said subtitle into said array successive to said word or idiom in said subtitle and
associating timing with said array; said timing is for playing said array as a subtitle in said timing while playing said multimedia content.
